(19) United States
(12) Patent Application Publication
(10) Pub. No.: US 2009/0138865 A1
(43) Pub. Date: May 28, 2009

(54) Performing an operating system upgrade without multiple system interruptions

(76) Inventors: Richard L. Furbee, West Chester, PA (US); Randolph C. Reist, Royersford, PA (US); Joseph Lerch, III, Pottstown, PA (US); Joseph Neill, East Fallowfield, PA (US); Jim Thompson, West Chester, PA (US)

Correspondence Address: UNISYS CORPORATION, UNISYS WAY, MAIL STATION: E8-114, BLUE BELL, PA, 19424, US

(21) Appl. No.: 11/009,793

(22) Filed: Dec. 10, 2004

(51) Int. Cl. G06F 9/44

(52) U.S. Cl. 717/168

(57) ABSTRACT

A method for upgrading an operating system (OS) on a computing system without system interruption begins by installing an upgraded OS. A boot pointer is set to point to a memory location that points to the upgraded OS. The computing system is booted into the upgraded OS, and the upgraded OS receives and processes commands. The boot pointer on the computing system's disk is updated to point to the upgraded OS if a user instructs the computing system to make the upgraded OS permanent, whereby the OS is upgraded without interrupting the computing system. The OS may also be upgraded automatically, without instruction from the user, if predetermined criteria are satisfied.

### FIELD OF INVENTION

The present invention relates generally to computer operating systems, and more particularly, to a method and system for upgrading an operating system without multiple system interruptions.

### BACKGROUND

In an “always on” computer system, such as a banking system, one goal is to improve the availability metric. For example, an availability of 99.99% is 52 minutes, 24 seconds per year that the system is down, and 99.999% availability is 5 minutes, 15 seconds of downtime per year. Higher availability translates into better system reliability. There are many different methods available to reduce a system's downtime, and reducing the number of system boot cycles is one such method. Intentional reboots are a leading concern related to downtime. In a mission-critical setting, any extended downtime can lead to large losses in terms of data integrity, customer satisfaction, or a company's revenue.

Any type of upgrade to a computer's operating system (OS) requires some downtime to install. During the course of a single year, several types of upgrades may be issued, including, for example, bug fixes multiple times per year, minor or support releases once or twice a year, and major upgrades once a year. Even in an ideal setting, installing several upgrades during the course of a year will likely lead to more than five minutes of downtime.

How an upgrade is implemented depends on the OS. For example, in a Windows® environment, every upgrade is installed as a “hard” change, meaning that the user cannot try out the upgrade before it is permanently installed on the user's system. If there is some incompatibility between other programs the user is running and the upgraded OS, the user has to attempt to uninstall the upgrade and reinstall the previous version of the OS. This can be a tedious and time-consuming process, leading to many hours of time spent uninstalling and reinstalling software.

Other OSs, for example MCP, permit a user to make a temporary OS change; in MCP, this is referred to as a “soft CM” (change MCP). This temporary change forces the system to restart into the upgraded OS by updating the boot pointer in memory to point to the upgraded OS file. The user is then free to perform various tests in the newly upgraded OS. This functionality can be useful in situations where an emergency upgrade is needed to repair a system that is running in a crippled condition, and there is insufficient time to properly test the upgrade prior to installation. One possible result is that the upgrade could address the emergency situation, but could cause side effects leading to other problems. In such circumstances, a permanent installation of the upgrade would be undesirable. It is noted that the temporary OS exists for one boot cycle only; i.e., if the system reboots for any reason, the boot pointer in memory to the temporary OS is erased, and the system looks to the boot pointer on disk which points to the permanent OS.

If a problem is discovered after a temporary change (e.g., side effects occur), the user may simply reboot the system and the OS is restored to the state it was in before the test (i.e., to the previous version), by using the OS code file specified in the Boot Strap Area (BSA) of the disk. However, if the user desired to make the new OS the permanent OS for the system, the OS would update the BSA and then initiate a system restart to read the information off of the disk's BSA. This has a negative impact on overall system availability by requiring an additional boot cycle, which leads to additional system downtime.

An example of a method 100 of changing the OS (the example using the MCP OS) is shown in FIG. 1. The method 100 begins by issuing a change MCP (CM) command (step 102). The code file is verified to determine if it is a valid MCP code file (step 104). If the code file is not valid (step 106), then a determination is made whether the error is correctable (step 108). Certain types of errors can be corrected by the user, such as a typographical error in a file name and the system cannot locate the file due to the error. Other types of errors are not correctable, such as an MCP that is not proper for the machine on which it's running; e.g., the wrong microcode for the hardware.

If the error is not correctable, then the method terminates (step 110). If the error is correctable (step 108), then a warning is displayed prompting the user to identify a valid code file (step 112). The system then waits for a response from the user (step 114). When the user supplies a response, a determination is made whether that response is valid (step 116). If the response is not valid, then the method determines if the invalid response is a correctable error (step 108), as described above. If the response is valid (step 116), then the newly identified code file is verified to see if it is a valid MCP code file (step 104), as described above. If the user enters a discontinue (DS) command as a response (step 116), then the method terminates (step 110). It is noted that while waiting for a response from the user (step 114), the system can wait indefinitely.

If the code file is valid (step 106), then a determination is made whether the CM command was for a temporary CM or a permanent CM (step 120). If the command was for a temporary CM, then an information array (MCPINFO) is updated with pointers and other information relating to the memory location pointing to the temporary MCP (step 122). MCPINFO contains information relating to the current running OS instance and is used by the boot process to identify the location of the temporary MCP file. The MCPINFO array is saved to disk (step 124) and a boot (halt/load) into the temporary MCP is performed (step 126). The temporary MCP is also stored on disk, and the boot information required to access the temporary MCP is stored in memory. This boot information includes the location of the temporary MCP file, so that the BSA that is stored on the disk does not need to be accessed. The system then operates normally with the temporary MCP.

If the CM command was for a permanent CM (step 120), then the MCPINFO array and the BSA are updated with permanent MCP pointers and information (step 130). The MCPINFO array and the BSA are saved to disk (step 132) and the system reboots (halt/load) from the disk (step 134). A permanent CM can also be referred to as a “hard CM.”

After the halt/load (steps 126 or 134), the system operates normally under the OS, regardless of whether it is temporary or permanent. A determination is made whether the current MCP is temporary or permanent (step 140). If it is a temporary MCP (via a soft halt/load), then an indicator is set to identify the MCP as temporary and that on the next reboot, the system should use the permanent MCP (step 142). The method then terminates (step 110). If is it a permanent MCP (step 140), then nothing further needs to be done, and the method terminates (step 110). This determination (step 140) is made because if the soft halt/load functions without errors, then the system can run with the temporary MCP. However, if the soft halt/load fails for some reason, then the system needs to run a hard halt/load (i.e., reboot using the BSA stored on disk) because the memory containing the soft boot information will be erased.

Following the successful soft CM of an MCP (step 126), a second CM is required to make the change permanent. This CM and subsequent associated halt/load (step 134) impose an interruption to the system's uptime and have a negative effect on the user's work environment. A soft CM is a way to reduce downtime because it allows a user to try out an MCP and have an easy way out if the new MCP doesn't work how the user prefers. A bad CM can cause a situation where the user must run the LOADER program to correct the problem, which leads to more downtime. Some users would rather CM twice (soft CM, then hard CM) than risk having to run LOADER.

The present invention simplifies this process by allowing the soft CM to become permanent without the need to perform the second halt/load. Hardening a soft MCP eliminates the need for a second CM and reduces the chance that a user will need to run LOADER to correct an error.

### SUMMARY

Because the boot information during a soft boot is a temporary pointer stored in memory, the boot information contained in the BSA stored on disk is not being accessed. The OS updates the BSA on the system's hard disk while the system is running and sets the appropriate indicators to show that the system is running on a permanent OS. The update occurs while the system is running and does not require a complete restart. The change is performed in ways that have little to no effect on the overall system availability.

A method for upgrading an operating system (OS) on a computing system without system interruption begins by installing an upgraded OS. A boot pointer is set to point to a memory location that points to the upgraded OS. The computing system is booted into the upgraded OS, and the upgraded OS receives and processes commands. The boot pointer on the computing system's disk is updated to point to the upgraded OS if a user instructs the computing system to make the upgraded OS permanent, whereby the OS is upgraded without interrupting the computing system. The OS may also be upgraded automatically, without instruction from the user, if predetermined criteria are satisfied.

A system for upgrading an operating system (OS) on a computing system without system interruption includes a controller, a disk, a memory, and a boot pointer. The disk stores a permanent OS and an upgraded OS. The memory points to the upgraded OS. The boot pointer points to which one of the permanent OS and the upgraded OS will be executed. The controller accesses the boot pointer and executes the OS pointed to by the boot pointer, whereby if the permanent OS is to be executed, the boot pointer points to the permanent OS on the disk, and if the upgraded OS is to be executed, the boot pointer points to the memory, which in turn points to the upgraded OS on the disk.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIGS. 1a and 1b show a flowchart of a prior art method for making a temporary operating system permanent;

FIG. 2 is a flowchart of a method for upgrading an operating system in accordance with the present invention;

FIGS. 3a and 3b show a flowchart of the method shown in FIG. 2 as applied to the MCP operating system;

FIG. 4a is a block diagram of a system embodying the present invention before the operating system is permanently upgraded; and

FIG. 4b is a block diagram of the system shown in FIG. 4a after the operating system upgrade is made permanent.

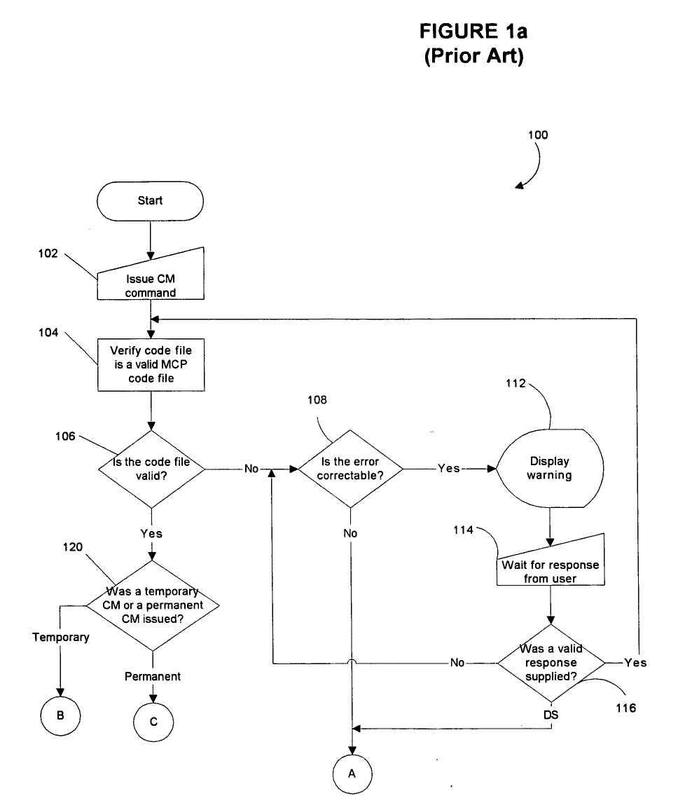

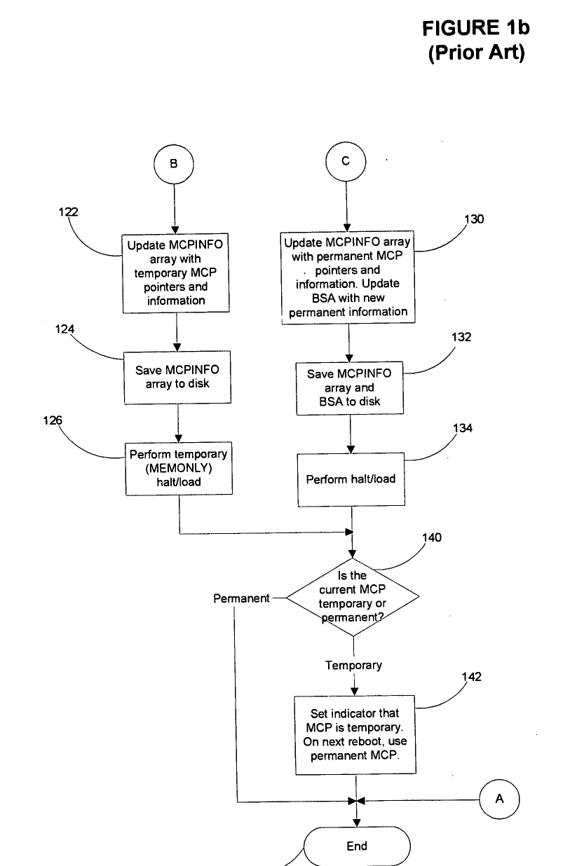

### DETAILED DESCRIPTION OF THE PREFERRED EMBODIMENTS

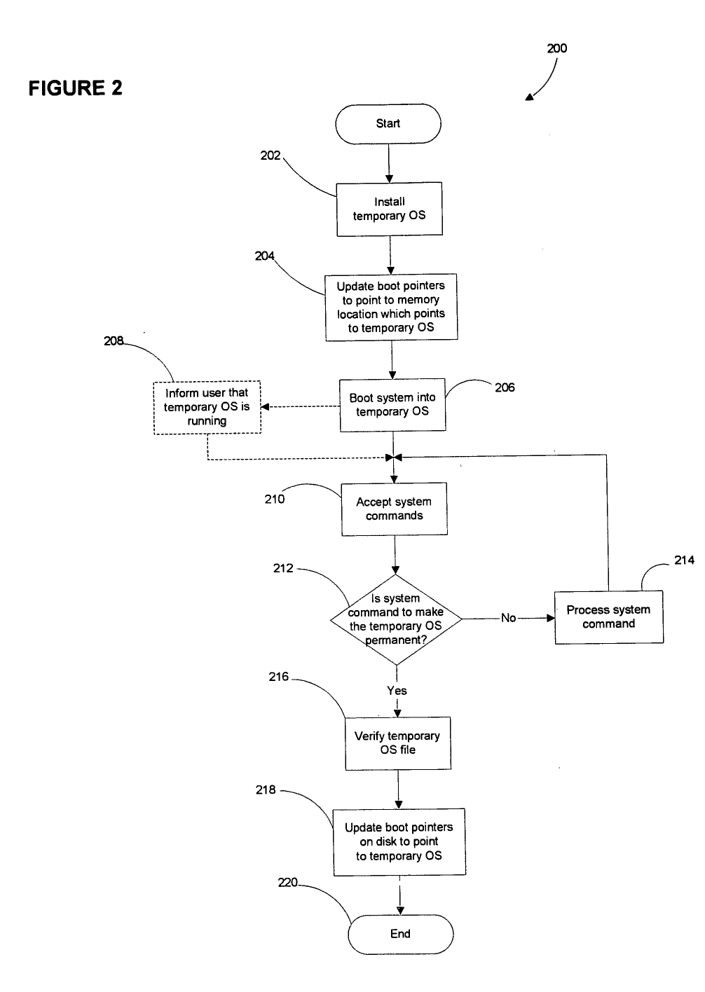

A method 200 for upgrading an OS in accordance with the present invention is shown in FIG. 2. The method 200 begins by installing a temporary OS file (i.e., the upgrade) to a system disk (step 202). The system's boot pointers are updated to point to a memory location that points to the temporary OS (step 204) and the system is booted into the temporary OS (step 206). As an optional step, the user can be informed that the temporary OS is running, rather than the permanent OS (step 208). With the temporary OS operating, it is ready to accept system commands (step 210).

If the system command is not to make the temporary OS permanent (step 212), then the system processes the command as it would with any other system command (step 214) and continues to accept commands (step 210).

If the system command is to make the temporary OS permanent (step 212), then the temporary OS file is verified to ensure that it is not corrupted (step 216). It is noted that the verification step (step 216) is performed as a “sanity check” of the OS file, and can be skipped. The boot pointers stored in the BSA on disk for the permanent OS are updated to point to the current/temporary OS, since the temporary OS is now the permanent OS (step 218), and the method terminates (step 220).

The BSA maintains a pointer to the OS file to load, and the BSA is stored in a particular area on the disk. When the temporary OS is installed, a soft boot pointer is set to point to the temporary OS file such that when the soft boot is initiated, the temporary OS is loaded. While the temporary OS is running, any type of system reboot will look to the BSA stored on disk to locate the permanent OS file. Essentially, making the temporary OS the permanent OS requires updating the boot pointer on disk to point to the temporary OS.

In an alternate embodiment of the present invention, the temporary OS can be automatically hardened by the system, without further intervention by the user. The criteria to be applied for the automatic hardening can be supplied by the user when the OS upgrade is installed, or can be supplied at a later time. For example, the user could specify that if the system runs for a predetermined period of time (e.g., three days) without any errors, then the OS upgrade should be made permanent. The criteria to be evaluated can be open-ended, including, but not limited to, the length of runtime without errors, a certain number errors over a given period of time, or the types of errors that can be permitted to occur. In addition, the criteria selected can be combined or performance thresholds can be established, such that the user can customize the determination whether to automatically harden the OS upgrade. If the selected criteria are not met, or if a certain trigger condition is met (e.g., a fatal error occurs), then the automatic hardening process is deactivated, and the user can manually harden the OS upgrade, as described above.

Regardless of the criteria selected for the automatic hardening, the user is also able to deactivate the automatic hardening, such that a manually initiated hardening process would be required. The reason for this escape process is that the system may be running close to the threshold criteria specified by the user, but not sufficiently above the threshold to satisfy the user. For system integrity, it is better to provide the user with a way out of the automatic hardening process, than to force the user to accept a hardening he or she may be uncomfortable with.

### EXAMPLE

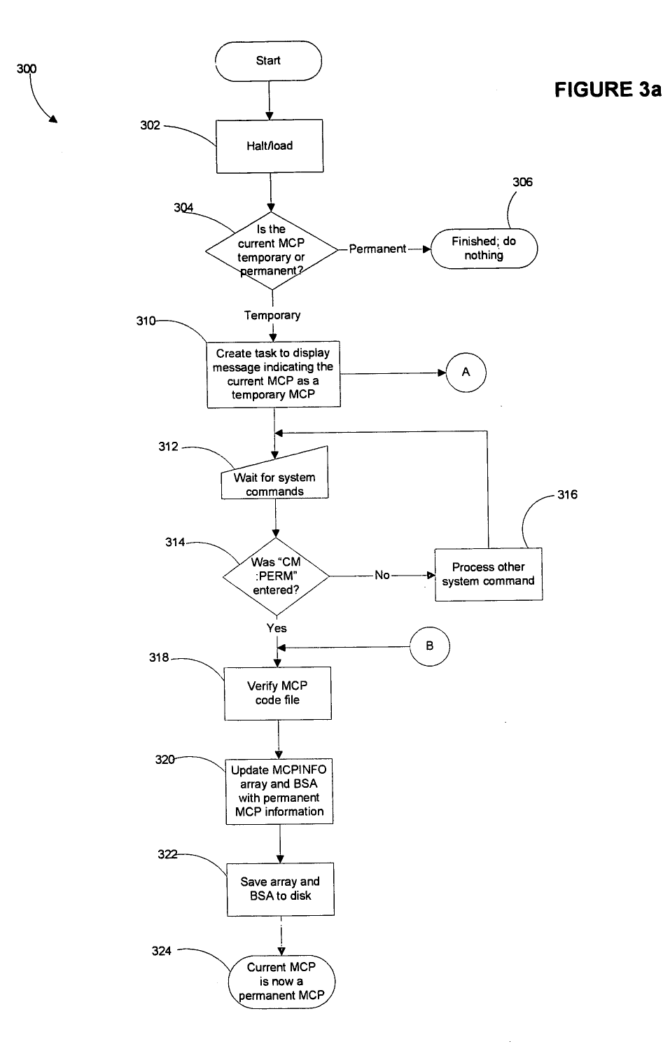

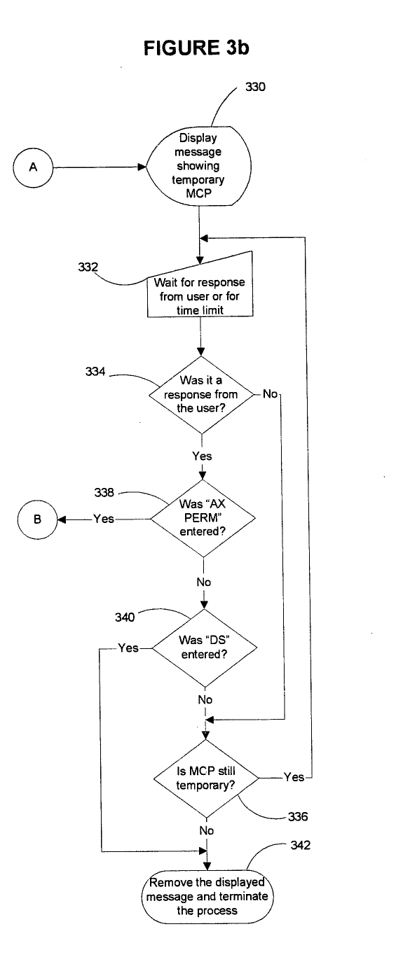

An example of the present invention as applied to the MCP OS is shown as a method 300 in FIGS. 3a and 3b. However, the inventive principles disclosed herein can be applied to any OS upgrades. The method 300 begins with a halt/load (step 302). A determination is made whether the MCP currently running is a temporary MCP or a permanent MCP (step 304). If the current MCP is permanent, then there is nothing further to do and the method terminates (step 306).

If the current MCP is temporary, then a task is created to display a message to the user indicating that the current MCP is temporary (step 310) and the system then waits for system commands (step 312). Each system command is evaluated (step 314) and if the system command is not “CM:PERM” (to make the current MCP permanent), then the system command is processed as normal (step 316) and the system continues to accept other commands (step 312).

If the “CM:PERM” command is entered (step 314), then the MCP code file is verified (step 318). It is noted that the verification step is performed as a “sanity check” of the code file, and can be skipped. The MCPINFO array and the BSA are updated with the permanent MCP information (step 320) and are saved to disk (step 322). The current MCP becomes the permanent MCP and the method terminates (step 324).

When the display task is created (step 310), it is forked off as a separate process. A message is displayed to the user indicating that the current MCP is a temporary MCP (step 330). The system then waits for a response from the user or for a time limit to expire (step 332). In a preferred embodiment, the time limit is 20 seconds. A determination is then made whether the user entered a response or whether the time limit expired (step 334). If there was no response from the user (meaning that the time limit expired), then a determination is made whether the current MCP is still the temporary MCP (step 336). If the MCP is still temporary, then the method waits for another response from the user or for another time limit (step 332), as described above.

If the user did enter a response, a determination is made whether the user entered an “AX PERM” (harden the soft MCP) command (step 338). If so, then the method continues by verifying the MCP code file (step 318), as described above.

If the user does not enter an “AX PERM” command (step 338), a check is made whether the user has entered a “DS” (discontinue) command to terminate the message display (step 340). If the user has not entered a “DS” command, then a determination is made whether the current MCP is still the temporary MCP (step 336), as described above. If the user has entered a “DS” command (step 340) or if the temporary MCP has been hardened (step 336), then the displayed message is removed because the problem has been addressed and the process (i.e., the waiting stack) terminates (step 342).

Although steps 310-324 and 330-342 are separate processes within the system, they do interact with each other. In MCP, steps 310-324 are referred to as a control stack and steps 330-342 are referred to as a waiting stack. Under MCP, a screen display is divided into a number of different areas, with each area being capable of displaying information relating to different processes running under the OS. When a waiting message is displayed, it is done so in a separate area of the screen from the main control area. As described above, there are two different ways for a user to harden the temporary MCP: (1) via the control stack and entering the “CM:PERM” command (step 314); and (2) via the waiting stack and entering the “AX PERM” command (step 338). If either of these methods are used to harden the MCP, the other is not needed; this is the reason for the check made in step 336.

One mechanism of tracking when a temporary OS change is performed is to set a bit in a reserved section of memory that indicates the presence of the temporary OS. When this bit is encountered, a message is displayed to the user that informs them that the current OS is a temporary OS (steps 310, 330). When the message is acknowledged with the “PERM” parameter (step 338), the process of updating the permanent OS information (steps 318-324) is started. Once completed, the reserved bit is reset and the system is considered to be running on the permanent OS.

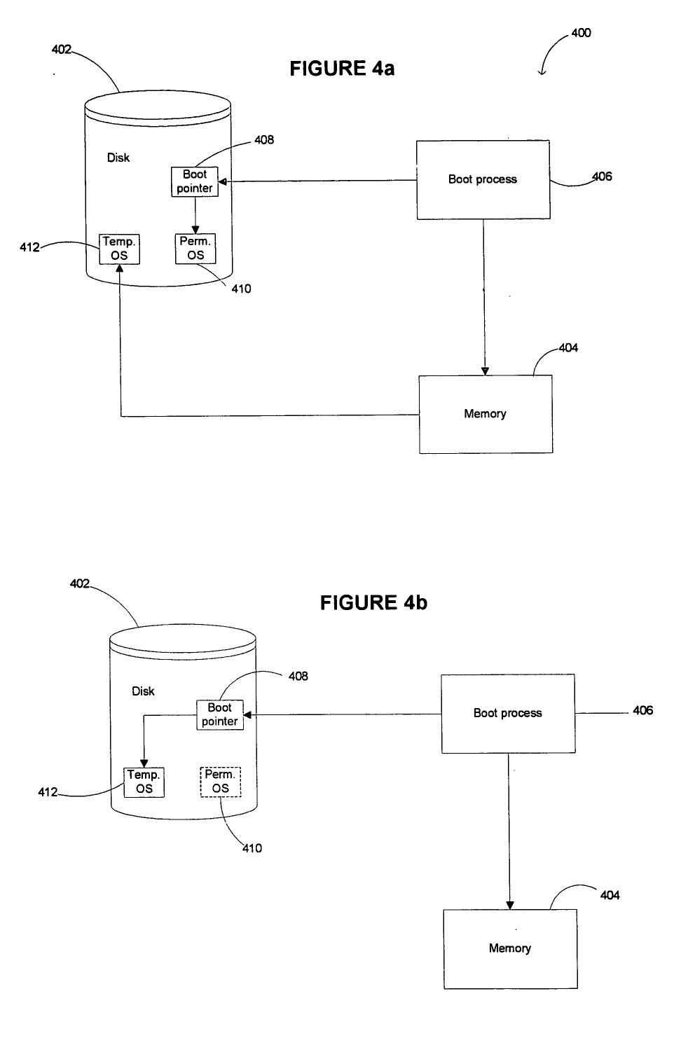

A system 400 constructed in accordance with the present invention is shown in FIGS. 4a and 4b. The system 400 includes a disk 402, a memory 404, and a boot process 406. The disk 402 includes a boot pointer 408, a permanent OS 410, and a temporary OS 412. As shown in FIG. 4a, the boot pointer 408 points to the permanent OS 410 and the memory 404 is loaded with the location of the temporary OS 412.

When the temporary OS 412 is loaded, the boot process 406 is invoked and looks to the memory 404 to determine the location of the temporary OS 412 on the disk 402. On a subsequent reboot, the memory 404 is erased, and the boot process 406 looks to the boot pointer 408 stored on the disk 402 to load the permanent OS 410.

When the temporary OS 412 is made the permanent OS 410, the pointer stored in the memory 404 is copied to the boot pointer 408, such that the boot pointer 408 now points to the temporary OS 412, as shown in FIG. 4b. This changing of the boot pointer 408 makes the temporary OS 412 permanent.

It is noted that the present invention may be implemented in a variety of systems and that the various techniques described herein may be implemented in hardware or software, or a combination of both. Although the features and elements of the present invention are described in the preferred embodiments in particular combinations, each feature or element can be used alone (without the other features and elements of the preferred embodiments) or in various combinations with or without other features and elements of the present invention. While specific embodiments of the present invention have been shown and described, many modifications and variations could be made by one skilled in the art without departing from the scope of the invention. The above description serves to illustrate and not limit the particular invention in any way.

1. A method for upgrading an operating system (OS) on a computer without system interruption, the method comprising the steps of:
installing an upgraded OS on the computer;
setting a boot pointer to point to a memory location that points to the upgraded OS file;
booting the computer into the upgraded OS;
receiving and processing commands by the upgraded OS; and
updating the boot pointer on the computer's disk to point to the upgraded OS if a user instructs the computer to make the upgraded OS permanent, whereby the OS is upgraded without interrupting the computer.

2. The method according to claim 1, wherein the booting step includes: following the boot pointers to the memory location and then to the upgraded OS file;
reading the upgraded OS file; and
executing the upgraded OS file.

3. The method according to claim 1, wherein the updating step includes verifying the upgraded OS file is a valid OS image before updating the boot pointer.

4. The method according to claim 1, further comprising the step of:
informing the user while the upgraded OS is running, that the currently running OS is the upgraded OS, the informing step being performed after the booting step.

5. The method according to claim 1, wherein the updating step is performed automatically if predetermined criteria indicate that the upgraded OS is stable.

6. The method according to claim 5, wherein the predetermined criteria relating to the stability of the upgraded OS are established by the user during the installing step.

7. A method for automatically upgrading an operating system (OS) on a computer without system interruption, the method comprising the steps of:
installing an upgraded OS on the computer;
setting a boot pointer to point to a memory location that points to the upgraded OS;
booting the computer into the upgraded OS;
receiving and processing commands by the upgraded OS;
establishing criteria which must be satisfied before the OS will be upgraded; and
updating the boot pointer on the computer's disk to point to the upgraded OS if the criteria are satisfied, whereby the OS is automatically upgraded without interrupting the computer and without additional user action.

8. A system for upgrading an operating system (OS) on a computer without system interruption, the system comprising:
a controller;
a disk, said disk storing a permanent OS and an upgraded OS;
a memory, said memory pointing to the upgraded OS;
a boot pointer, said boot pointer pointing to which one of the permanent OS and the upgraded OS will be executed; and
said controller accessing said boot pointer and executing the OS pointed to by said boot pointer, whereby
if the permanent OS is to be executed, said boot pointer points to the permanent OS on said disk, and
if the upgraded OS is to be executed, said boot pointer points to said memory, which in turn points to the upgraded OS on said disk.
